(19) United States
(12) Patent Application Publication
(10) Pub. No.: US 2012/0178835 A1
(43) Pub. Date: Jul. 12, 2012

(54) USE OF BRANCHED ADDITION COPLYMERS IN FILMS AND MEMBRANES

(75) Inventors: Paul Hugh Findlay, Liverpool (GB); Sharon Todd, Liverpool (GB); Steven Paul Rannard, Liverpool (GB); Brodyck James Lachlan Royles, Liverpool (GB); Neil John Simpson, Liverpool (GB); Roselyne Marie Andree Baudry, Liverpool (GB)

(73) Assignee: Unilever PLC, London (GB)

(21) Appl. No.: 13/496,490

(22) PCT Filed: Sep. 16, 2010
(86) PCT No.: PCT/GB2010/001740

§ 371 Date: Mar. 15, 2012

Related U.S. Application Data
(60) Provisional application No. 61/300,176, filed on Feb. 1, 2010.

(30) Foreign Application Priority Data
Sep. 17, 2009 (GB) 0916337.9

(51) Int. Cl. B01J 41/14; C08J 5/22

(52) U.S. Cl. 521/27

(57) ABSTRACT

The present invention relates to branched addition copolymers which can be cured post synthesis to form films or membranes, methods for their preparation, compositions comprising such copolymers and their use in film or membrane preparation.

This application is the national phase entry of PCT Application No. PCT/GB2010/001740, filed Sep. 16, 2010, which claims priority to GB Application No. 0916337.9, filed Sep. 17, 2009 and US Application No. 61/300,176 filed Feb. 1, 2010. The disclosures of said applications are hereby incorporated herein by reference.

### TECHNICAL FIELD

The present invention relates to branched addition copolymers which can be cured post synthesis to form films or membranes, methods for their preparation, compositions comprising such copolymers and their use in film or membrane preparation.

### BACKGROUND OF THE INVENTION

The present invention relates to branched addition copolymers which can be cured via a cross-linking reaction and their use as films or membranes.

It is possible to prepare polymers with inherent functionalities that can be post modified via a chemical reaction. The chemical reaction may take place between functionalities on a single polymer or between two or more polymers. In addition, the chemical reaction may take place either with or without a catalyst or initiator, or involve a specific small molecule all with the aim of producing a three-dimensional cross-linked matrix. This post modifying chemical reaction is often referred to as a curing reaction and may create inter or intra molecular covalent or ionic bonding. The curing reaction typically takes place in-situ in the final form of the product and may lead to for example a film or membrane.

Reactive moieties can be incorporated into a polymer either through the choice of a suitable reactive monomer or by post-functionalisation of the prepared polymer. The functionalities may then be reacted with themselves, for example through the incorporation of unsaturated groups, and cured with or without the use of a suitable catalyst or initiator. Alternatively, mutually reactive units can be included either in the same polymer structure or alternatively, a polymer with a first functionality can be reacted with a polymer or small molecule with a complimentary reactive unit.

Suitable curing reactions include the polymerisation of for example a pendant alkene unit such as a vinyl or allyl unit, or alternatively, the reaction may be between two reactive units to form a covalent bond, such as the formation of an ester or amide link, the ring opening of an epoxide, formation of a urethane or urea bond, nucleophilic substitution or addition, electrophilic substitution or addition or via the formation of an ionic linkage, for example through the formation of a salt bridge.

Curing reactions may take place at ambient temperature or through thermal means or via a photochemical reaction, typically via a UV source. Additional initiators may also be used, for example a free radical initiator where the reactive species is an alkene unit. Catalysts may also be used to accelerate the curing step such as for example a strong acid in the case of the preparation of an ester or amide linkage, or a transition metal compound in the case of urethane or urea formation.

Cured polymers have the advantage of being more environmentally resilient than uncured materials due to the cross-linked network. The curing mechanism does however render the material essentially intractable hence the requirement for pre-formation into the desired end product prior to the cross-linking step.

Cured polymer films or membranes are used in a number of applications. As mentioned previously, the formation of a three dimensional network during the curing step improves the resilience of the film or membrane. Such formulations include alkyd, epoxy or polyurethane systems.

A membrane is a selective barrier between two phases, which may be natural or synthetic. Membranes are typically polymeric in nature and are vital in many natural or industrial applications. Membranes may also have an inherent porosity such as those used in filtration technologies or may be non-porous dense films such as those used in gas separation or pervaporation applications. Selective membranes can have a defined inherent porosity in their final state and can be used in a variety of separation applications. Polymeric membranes can be neutral or charged in nature and are usually cross-linked or at least insoluble in their final form. The polymer can be a homogeneous or a heterogeneous mixture of varying polymers, with fillers present to improve the membrane or film properties. Where the membrane is cross-linked, the material is usually cast and cured into the final form and the finished membrane is essentially intractable. These materials can be considered to be a selective polymeric film and as such the film properties of the membrane can be tuned through the choice of constituent monomers in the polymer, and by the incorporation of additional polymers, fillers or choice of cross-linker.

In some cases polymeric membranes can be prepared and cast as a polymer film through extrusion at high temperature, this is true in the case of Nafion® and other thermoplastic materials and/or fabrication techniques. This procedure is expensive requiring high temperatures and pressures and the polymer must therefore be thermally stable with good film properties.

An alternative method of forming a polymer membrane involves casting a film of monomers which can be polymerised, and usually cross-linked, into the final form. This method can be performed with or without solvent, occasionally a poor solvent, a so-called porogen, or a polymer is used which can lead to the formation of a porous structure in the final membrane.

Polymers or pre-polymers can also be employed where a polymer is solution or melt cast and post-reacted to form a cross-linked membrane. This reaction can occur through inter or intra molecular bonding. Two-pack formulations can also be used where the polymer reacts with another macromolecule or a small molecule to form a cross-linked structure. Through the choice of polymers, fillers and solvent a material can be prepared with good membrane and film properties.

In the cases listed above a number of reactive chemistries can be exploited. Essentially any reaction that can form a covalent or ionic bond between two molecules can be utilised. Here follows a non exclusive list of the functional groups and reactions that can be incorporated into and instigated to provide a cured polymer.

In all of the cases below, the functional group can be incorporated into the polymer structure via the use of functional monomers or alternatively the reactive moiety can be introduced through a further reactive step onto a pre-formed polymer. In most cases the reaction occurs by means of both inter and intra molecular reactions.

Alkene polymerisation. An unsaturated carbon-carbon unit in the form of for example an alkene bond, can be essentially polymerised, usually via a free radical procedure. In such a mechanism the polymerisation occurs via the introduction of a free radical initiator which is then dissociated thermally, by the use of UV radiation or via a chemical means such as a redox reaction, to generate free radicals which react with the unsaturated units and provide a cured polymer, or alternatively via a transition metal catalyst “dryer” in the case of alkyd systems. Allyl, vinyl or alkyd functional polymers are typically used in this type of curing.

In the following cases the mutually reactive carbon units described can be present within the same polymer structure or, the reactive moieties may arise through the reaction of two polymers, or, by the reaction of one polymer and one small molecule, wherein the complimentary functionalities on each polymer or molecule may react.

Ester or amide formation. Alcohol or amine and carboxylic acid functionalities can be reacted to provide an ester or an amide linker unit respectively. These linking reactions are typically thermally initiated in the presence of a strong acid catalyst. Another route to these types of linkages is the reaction of an alcohol or amine with an anhydride or azlactone, or through the transesterification or transamidation of an activated ester such as that found in the monomer methyl acrylamidoglycolate methyl ether.

Epoxide ring-opening. In this case a compound possessing an epoxide ring is reacted with a nucleophilic material, usually a primary or secondary amine The amine epoxy reaction is catalysed by a hydroxylic species such as phenols and alcoholic solvents. Epoxides can also react with other nucleophilic species such as thiols or carboxylic acids, in the presence of a tri-alkyl or aryl phosphine catalyst. The epoxide can also be homopolymerised via the use of a Lewis or Brönsted acid such as boron tri-fluoride or tri-fluoromethane sulfonic acid.

Isocyanate chemistry. In this case, an isocyanate group is reacted with a group possessing an active hydrogen such as a hydroxyl group, a thiol or an amine The polymer usually possesses the active hydrogen nucleophile and is reacted with a smaller molecular weight di- or poly-isocyanate, such as tolylenediisocyanate. Blocked isocyanates, where the isocyanate unit has been reacted with a labile monofunctional active hydrogen compound can also be used, in which case the isocyanate is rendered less reactive and the formulation can be stored as a stable one-pack formulation.

Thiol-ene chemistry. In thiol-ene chemistry, the radical reaction between a thiol functionality and an electron-rich olefin is utilised to form a thioether linkage. These reactions are typically initiated by photochemical means.

Nucleophilic substitution. These reactions involve the substitution of a labile leaving group with a suitable nucleophile. An example of such a reaction involves the substitution of an alkyl halide with an amine or alkoxide. In the case of the reaction of the alkyl halide with an amine, a charged species is formed which can be attractive in the formation of a charged membrane.

Electrophilic addition. In this case, an electrophile is reacted with a suitable electron-rich moiety. An example of this cross-linking reaction is the reaction of an activated aryl unit with an electrophile such as an acid chloride, usually in the presence of a Lewis acid catalyst.

Disulfide curing. The reaction of two thiol units to form a disulfide can be undertaken through oxidation, for example by the use of hydrogen peroxide.

Silicone curing systems. The formation of siloxane linkages can be achieved through the reaction of an alkyloxysilane functionality where the curing proceeds via the elimination of a carboxylic acid, for example acetic acid in the case of an acetoxysilyl unit.

Linear polymers are commonly used in many applications due to their high solubility and ease of preparation. Due to their architectures these polymers can give rise to high viscosity solutions or melts, in addition they can be extremely slow or difficult to dissolve or melt to give isotropic liquids. The high viscosity of these solutions can be problematic in film or membrane formulation where a large amount of solvent is required in order to provide a workable formulation. Where the solvent is organic in nature this can lead to a large amount of volatile organic compound (VOC) being necessary to use the linear polymer effectively. Increasing legislation to decrease the VOC levels of many formulations makes this undesirable. Linear addition polymers typically also have the functional group pendant to the main chain of the polymer, this can give rise to slow curing reactions due to the inaccessibility of functional groups within the interior of the polymer structure during the curing reaction. This in turn leads to longer cure times and higher cure temperatures in thermally mediated reactions.

Linear polymers can also give rise to incomplete curing. Due to the architecture of these materials the membrane can also swell significantly in formulations leading to poor substrate adhesion and poor membrane properties. Swelling of a membrane during use is particularly problematic as it can lead to failure of the polymer membrane properties or the device itself

The use of linear polymers can also lead to poorly cross-linked or open networks when cured into a film or membrane. Where a highly dense film or membrane is required, or where a high concentration of functionalities or charge is required in the finished film or membrane, this can be unfavourable. This can also lead to poorer mechanical strengths for membranes prepared using linear polymers.

The curing rate of a linear polymer system is proportional to the molecular weight of the macromolecule concerned. Ideally high molecular weight materials are preferred. However due the sharp increase in solution or melt viscosity of the formulation with increasing molecular weight a compromise in molecular weight must be achieved to avoid high amounts of solvent (typically a VOC) or temperature, in the case of melt processed systems, in the formulation.

It has now been found that these disadvantages, namely the high viscosity of polymer systems, low cure rate, low density of functional groups, poor mechanical strength or incomplete cross-linking can however be addressed by using a branched architecture.

### Branched Polymers

Branched polymers are polymer molecules of a finite size which are branched. Branched polymers differ from cross-linked polymer networks which tend towards an infinite size having interconnected molecules and which are generally not soluble. In some instances, branched polymers have advantageous properties when compared to analogous linear polymers. For instance, solutions of branched polymers are normally less viscous than solutions of analogous linear polymers. Moreover, higher molecular weights of branched copolymers can be solubilised more easily than those of corresponding linear polymers. In addition, as branched polymers tend to have more end groups than a linear polymer they generally exhibit strong surface-modification properties. Thus, branched polymers are useful components of many compositions and can be utilised in the formation of polymer films or membranes.

Branched or hyperbranched polymers can also be used in curable systems, unlike dendrimers they typically show non-ideal branching in their structure and can posses polydisperse structures and molecular weights. Their preparation however can be much easier than their dendrimer counterparts and although their ultimate structure is not perfect or monodisperse they are more suitable for a number of industrial applications.

Branched polymers are usually prepared via a step-growth mechanism via the polycondensation of suitable monomers and are usually limited by the choice of monomers, the chemical functionality of the resulting polymer and the molecular weight. In addition polymerisation, a one-step process can be employed in which a multifunctional monomer is used to provide functionality in the polymer chain from which polymer branches may grow. However, a limitation on the use of a conventional one-step process is that the amount of multifunctional monomer must be carefully controlled, usually to substantially less than 0.5% w/w in order to avoid extensive cross-linking of the polymer and the formation of insoluble gels. It is difficult to avoid cross-linking using this method, especially in the absence of a solvent as a diluent and/or at high conversion of monomer to polymer.

WO 99/46301 discloses a method of preparing a branched polymer comprising the steps of mixing together a monofunctional vinylic monomer with from 0.3 to 100% w/w (of the weight of the monofunctional monomer) of a multifunctional vinylic monomer and from 0.0001 to 50% w/w (of the weight of the monofunctional monomer) of a chain transfer agent and optionally a free-radical polymerisation initiator and thereafter reacting said mixture to form a copolymer. The examples of WO 99/46301 describe the preparation of primarily hydrophobic polymers and, in particular, polymers wherein methyl methacrylate constitutes the monofunctional monomer. These polymers are useful as components in reducing the melt viscosity of linear poly(methyl methacrylate) in the production of moulding resins.

WO 99/46310 discloses a method of preparing a (meth)acrylate functionalised polymer comprising the steps of mixing together a monofunctional vinylic monomer with from 0.3 to 100% w/w (based on monofunctional monomer) of a polyfunctional vinylic monomer and from 0.0001 to 50% w/w of a chain transfer agent, reacting said mixture to form a polymer and terminating the polymerisation reaction before 99% conversion. The resulting polymers are useful as components of surface coatings and inks, as moulding resins or in curable compounds, for example curable moulding resins or photoresists.

WO 02/34793 discloses a rheology modifying copolymer composition containing a branched copolymer of an unsaturated carboxylic acid, a hydrophobic monomer, a hydrophobic chain transfer agent, a cross linking agent, and, optionally, a steric stabilizer. The copolymer provides increased viscosity in aqueous electrolyte-containing environments at elevated pH. The method for production is a solution polymerisation process. The polymer is lightly cross-linked, less than 0.25%.

U.S. Pat. No. 6,020,291 discloses aqueous metal working fluids used as lubricant in metal cutting operations. The fluids contain a mist-suppressing branched copolymer, including hydrophobic and hydrophilic monomers, and optionally a monomer comprising two or more ethylenically unsaturated bonds. Optionally, the metal working fluid may be an oil-in-water emulsion. The polymers are based on poly(acrylamides) containing sulfonate-containing and hydrophobically modified monomers. The polymers are cross-linked to a very small extent by using very low amount of bis-acrylamide, without using a chain transfer agent.

Stamatialis and co-workers (Journal of Membrane science 310 (2008) 512-521) discloses the use of a hyperbranched polyester (Boltorn H40) to increase the gas permeability coefficients for polyimide membranes. The hyperbranched material is cast together with the polyimide to give the corresponding hybrid membrane. Although the Boltorn material is not covalently linked in any way in the membrane there is a marked increase in the permeability coefficients for nitrogen and oxygen with a modest (1% w/w) incorporation of the hyperbranched polymer.

Shi and co-workers (Journal of Membrane science 245 (2004) 35-40) describe the formation of an organic-inorganic hybrid membrane utilising the dendritic polyol Boltorn H20 which had been post-functionalised with acetoxysily units capable of undergoing a sol-gel curing process with a further polyalkoxysilane and phosphoric acid. The membrane showed excellent proton conductivity at high temperature and humidity which the authors attributed to the dendritic component of the cured membrane structure.

WO 03/104327A1 describes the formation of a highly gas impermeable film via the use of a functionalised hyperbranched polyester amide (HBPEA). The HBPEA is incorporated in a preferably post-cured film in conjunction with a quantity of polyvinylalcohol or derivative thereof. The film is then post-cured by incorporation of a further reactive molecule capable of reacting covalently with hydroxyl groups. The films were found to be effective barriers against oxygen.

### DETAILED DESCRIPTION

Polymers capable of undergoing a subsequent curing or cross-linking reaction are used in many everyday applications. Typically these polymers are of a linear architecture where the functional groups are either pendant to the polymer main chain or at the termini of the macromolecule. The polymers can be natural, synthetic or hybrid in composition and can either react via an intra or intermolecular mechanism. In the case of addition polymers the functionality is usually either pre-formed within the polymer structure through choice of suitable reactive monomers or incorporated through a further chemical reaction. In these cases the functionality is placed along the carbon main-chain of the material. The concentration and location of the functionality can be tuned through the ratios of functional monomers or by using a controlled technique respectively.

Problems associated with curing linear molecules. It has been now been found that the use of curable dendritic or branched polymers have a number of advantages over linear systems. The branched nature of dendritic or branched polymers means that these polymers give rise to solutions or melts of lower viscosity enabling higher solids compositions to be formulated. This then enables less solvent to be used which can be problematic where VOCs are employed. In many curable systems there is a growing trend toward high solids formulations, the presence of organic solvents is something of a liability as they impart flammability, high cost and in many cases toxicity and are almost entirely lost in the final cured system. Since the solvent usually plays no part in the curing mechanism, and in many cases hinders it, the removal of the solvent is preferential. The ability to formulate at high solids level is particularly attractive since it can lead to compositions with a higher concentration of active curable polymer thus leading to faster cure rates during film or membrane manufacture. In many applications cure rate is crucial in the preparation of films or membranes and where this is thermally initiated, a number of cost savings can be made. Due to the polyvalency in branched polymer systems there is also a greater availability of functional groups within the polymer structure and once more this can lead to faster cure times.

Due to this high accessibility of functional groups and fast onset of gellation during curing there is typically greater formulation-substrate interaction leading to greater substrate adhesion, lower swelling, greater permselectivity and higher tensile strength; particularly desirable for membranes. These membranes can be used in applications under hydrostatic, concentration or electrical potential differences.

Dendritic polymers are prepared via a multi-step synthetic route and are limited by chemical functionality and ultimate molecular weight, being prepared at a high end cost. Such molecules have therefore only limited high-end industrial applications. Branched polymers are typically prepared via a step-growth procedure and again are limited by their chemical functionality and molecular weight. However, the reduced cost of manufacturing such polymers makes them more industrially attractive. Due to the chemical nature of both of these classes of macromolecules (that is, such molecules typically possess ester or amide linkages), problems arising from their miscibility with olefin-derived polymers have been observed. This can be circumvented by the use of hydrocarbon-based, star-shaped polymers prepared via anionic polymerisation or the post-functionalisation of pre-formed dendrimers or branched species although this again leads to an increased cost in the materials.

Through previous disclosures the inventors have shown that branched polymers of high molecular weight can be prepared via a one-step process using commodity monomers. Through specific monomer choices the chemical functionality of these polymers can be tuned depending on the specific application. These benefits therefore give advantages over dendritic or step-growth branched polymers. Since these polymers are prepared via an addition process from commodity monomers, they can be tuned to give good miscibility with equivalent linear addition polymers. Since branched polymers comprise a carbon-carbon backbone they are not susceptible to thermal or hydrolytic instability unlike ester-based dendrimers or step-growth branched polymers. It has been observed that these polymers also dissolve faster than equivalent linear polymers.

When manufacturing a membrane the choice of polymer is also an important consideration. Since branched polymer formulations give rise to lower solution or melt viscosities, they can be applied more easily. This is particularly true in the case where the formulation is spray applied during manufacture, once more leading to significant cost savings.

In summary, the advantages of using branched curable polymers over linear systems are considerable, for example; higher solids content formulations can be achieved; low viscosity formulations can be prepared; less volatile organic compounds (VOCs) are required in the final formulation; faster cure rates can be achieved leading to faster processing times; greater substrate adhesion can be obtained; higher density of functionalities or charge can be achieved; denser cross-linked structures can be obtained; greater mechanical strength can be achieved; thinner robust films can be prepared; higher permselectivities can be achieved; lower electrical resistances can be obtained and a lower swelling of the final polymer membrane in use can also be achieved.

The branched copolymers of the present invention are branched, non-cross-linked addition polymers and include statistical, block, graft, gradient and alternating branched copolymers. The copolymers of the present invention comprise at least two chains which are covalently linked by a bridge other than at their ends, that is, a sample of said copolymer comprises on average at least two chains which are covalently linked by a bridge other than at their ends. When a sample of the copolymer is made there may be accidentally some polymer molecules that are un-branched, which is inherent to the production method (addition polymerisation process). For the same reason, a small quantity of the polymer will not have a chain transfer agent (CTA) on the chain end.

### Applications.

The following is a non-exhaustive list of potential applications for polymer films and membranes which includes: medical separation and diagnostics applications, ion-exchange applications, desalination, water purification, gas separation, fuel cells, pervaporation, energy generation, energy storage, filtration and sensors. In each application field the film or membrane composition may be tuned through a choice of the monomers and the curing of the material.

Therefore according to a first aspect of the present invention there is provided the use of a branched addition copolymer wherein the branched addition copolymer is cured to form a cross-linked film or membrane formulation and wherein the branched addition copolymer is obtainable by an addition polymerisation process, and wherein the branched addition polymer comprises a weight average molecular weight of 2,000 Da to 1,500,000 Da.

The branched addition copolymers according to the first aspect of the present invention comprises:

at least two chains which are covalently linked by a bridge other than at their ends; and wherein

the at least two chains comprise at least one ethyleneically monounsaturated monomer, and wherein

the bridge comprises at least one ethyleneically polyunsaturated monomer; and wherein

the polymer comprises a residue of a chain transfer agent and/or optionally a residue of an initiator; and wherein

the mole ratio of polyunsaturated monomer(s) to monounsaturated monomer(s) is in a range of from 1:100 to 1:4.

In addition, the branched addition copolymers are preferably cured after formation of the branched addition polymer in the addition polymerisation process.

Curing of a branched addition copolymers takes place by the addition of a reactive polymer, oligomer or small molecular weight reactive molecule. This may involve a thermal, photolytic, oxidative, reductive reaction or be by means of the addition of a catalyst or initiator.

The branched addition copolymers according to the first aspect of the present invention are prepared from monomers comprising one or more of the following groups: hydroxyl, mercapto, amino, carboxylic, epoxy, isocyanate, pyridinyl, vinyl, allyl, (meth)acrylate and styrenyl. Consequently, the branched addition copolymers are cured by means of the reaction of mutually reactive functional groups provided on the monomers.

The branched addition copolymers according to the first aspect of the present invention are polymerised to give less than 1% impurity. More specifically in the present invention the branched addition copolymers are polymerised to give less than 1% monomer impurity. The branched addition polymer preferably comprises a weight average molecular weight of 3,000 Da to 900,000 Da.

The cured branched addition copolymers used in a film or membrane according to the first aspect of the present invention are used in the application areas selected from the group comprising: medical separation and diagnostics applications, industrial purification and separation, ion-exchange applications, desalination, water purification, gas separation, pervaporation, fuel cells, energy generation, energy storage, filtration and sensors.

Also in accordance with the first aspect of the present invention the branched addition copolymer preferably comprises units selected from the group consisting of: styrene, vinyl benzyl chloride, 2-vinyl pyridine, 4-vinyl pyridine, methyl acrylate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, glycidyl methacrylate, divinyl benzene, ethyleneglycol dimethacrylate, ethyleneglycol diacrylate, triethylene glycol dimethacrylate, tetraethyleneglycol dimethacrylate, triethyleneglycol diacrylate, tetraethyleneglycol diacrylate, 1,3,5-triallyl-1,3,5-triazine-2,4,6(1H,3H,5H)-trione, dodecane thiol, hexane thiol, 2-mercaptoethanol and fragments arising from azobis isobutyronitrile, di-t-butyl peroxide and t-butyl peroxybenzoate.

More preferably the branched addition copolymer used according to the first aspect of the present invention comprises units selected from the group consisting of: styrene, vinylbenzyl chloride, glycidyl methacrylate, vinylbenzyl chloride, 2-vinyl pyridine, 4-vinyl pyridine, methyl acrylate, methyl methacrylate, butyl methacrylate, butyl acrylate, acrylic acid, methacrylic acid, acrylamide, methacrylamide, dimethyl acrylamide, dimethyl(meth)acrylamide, styrene sulfonic acid, 2-acrylamido 2-methylpropane sulfonic acid, divinyl benzene, ethyleneglycol dimethacrylate, ethyleneglycol diacrylate, triethylene glycol dimethacrylate, dodecane thiol, hexane thiol, 2-mercaptoethanol, azobis isobutyronitrile, di-t-butyl peroxide and t-butyl peroxybenzoate.

According to a second and third aspect of the present invention there is provided a film or membrane comprising a cured branched addition copolymer as described in relation to the first aspect of the present invention.

In relation to the film or a membrane prepared according to the second and third aspects of the present invention the film or membrane may preferably further comprises a hardener selected from: dibromopentane, dibromo hexane, dibromoheptane, dibromooctane, diiodo pentane, diidohexane, diiodoheptane, diiodooctane, tetramethylhexane 1,6 diaminohexane, tertamethyethylene diamine, tetramethylbutane 1,4 diamine, tolylene diisocyanate and hexamethylene diisocyanate.

The film or membrane may also comprise a support material. In addition, the film or membranes preferably comprise a permselectivity above 80%. More preferably the film or membranes comprise a permselectivity above 90%.

In addition, the film or membrane according to second and third apsects of the present invention, preferably comprise an electrical resistance below 5 Ω cm⁻².

The chain transfer agent (CTA) is a molecule which is known to reduce molecular weight during a free-radical polymerisation via a chain transfer mechanism. These agents may be any thiol-containing molecule and can be either monofunctional or multifunctional. The agent may be hydrophilic, hydrophobic, amphiphilic, anionic, cationic, neutral, zwitterionic or responsive. The molecule can also be an oligomer or a pre-formed polymer containing a thiol moiety. (The agent may also be a hindered alcohol or similar free-radical stabiliser). Catalytic chain transfer agents such as those based on transition metal complexes such as cobalt bis(borondifluorodimethyl-glyoximate) (CoBF) may also be used. Suitable thiols include but are not limited to C2 to C18 branched or linear alkyl thiols such as dodecane thiol, functional thiol compounds such as thioglycolic acid, thio propionic acid, thioglycerol, cysteine and cysteamine. Thiol-containing oligomers or polymers may also be used such as for example poly(cysteine) or an oligomer or polymer which has been post-functionalised to give a thiol group(s), such as poly(ethyleneglycol) (di)thio glycollate, or a pre-formed polymer functionalised with a thiol group. For example, the reaction of an end or side-functionalised alcohol such as poly(propylene glycol) with thiobutyrolactone, to give the corresponding thiol-functionalised chain-extended polymer. Multifunctional thiols may also be prepared by the reduction of a xanthate, dithioester or trithiocarbonate end-functionalised polymer prepared via a Reversible Addition Fragmentation Transfer (RAFT) or Macromolecular Design by the Interchange of Xanthates (MADIX) living radical method. Xanthates, dithioesters, and dithiocarbonates may also be used, such as cumyl phenyldithioacetate. Alternative chain transfer agents may be any species known to limit the molecular weight in a free-radical addition polymerisation including alkyl halides, ally-functional compounds and transition metal salts or complexes. More than one chain transfer agent may be used in combination. Non-thiol chain transfer agents such as 2,4-diphenyl-4-methyl-1-pentene can also be used.

Hydrophobic CTAs include but are not limited to linear and branched alkyl and aryl (di)thiols such as dodecanethiol, octadecyl mercaptan, 2-methyl-1-butanethiol and 1,9-nonanedithiol. Hydrophobic macro-CTAs (where the molecular weight of the CTA is at least 1000 Daltons) can be prepared from hydrophobic polymers synthesised by RAFT (or MADIX) followed by reduction of the chain end, or alternatively the terminal hydroxyl group of a preformed hydrophobic polymer can be post functionalised with a compound such as thiobutyrolactone.

Hydrophilic CTAs typically contain hydrogen bonding and/or permanent or transient charges. Hydrophilic CTAs include but are not limited to: thio-acids such as thioglycolic acid and cysteine, thioamines such as cysteamine and thio-alcohols such as 2-mercaptoethanol, thioglycerol and ethylene glycol mono- (and di-)thio glycollate. Hydrophilic macro-CTAs (where the molecular weight of the CTA is at least 1000 Daltons) can be prepared from hydrophilic polymers synthesised by RAFT (or MADIX) followed by reduction of the chain end, or alternatively the terminal hydroxyl group of a preformed hydrophilic polymer can be post functionalised with a compound such as thiobutyrolactone.

Amphiphilic CTAs can also be incorporated in the polymerisation mixture, these materials are typically hydrophobic alkyl-containing thiols possessing a hydrophilic function such as but not limited to a carboxylic acid group. Molecules of this type include mercapto undecylenic acid.

Responsive macro-CTAs (where the molecular weight of the CTA is at least 1000 Daltons) can be prepared from responsive polymers synthesised by RAFT (or MADIX) followed by reduction of the chain end, or alternatively the terminal hydroxyl group of a preformed responsive polymer, such as poly(propylene glycol), can be post functionalised with a compound such as thiobutyrolactone.

The residue of the chain transfer agent may comprise 0 to 80 mole % of the copolymer (based on the number of moles of monofunctional monomer). More preferably the residue of the chain transfer agent comprises 0 to 50 mole %, even more preferably 0 to 40 mole % of the copolymer (based on the number of moles of monofunctional monomer). However, most especially the chain transfer agent comprises 0.05 to 30 mole %, of the copolymer (based on the number of moles of monofunctional monomer).

The initiator is a free-radical initiator and can be any molecule known to initiate free-radical polymerisation such as for example azo-containing molecules, persulfates, redox initiators, peroxides, benzyl ketones. These may be activated via thermal, photolytic or chemical means. Examples of these include but are not limited to: 2,2′-azobisisobutyronitrile (AIBN), azobis(4-cyanovaleric acid), benzoyl peroxide, diisopropyl peroxide, tert-butyl peroxybenzoate (Luperox® P), di-tert-butyl peroxide (Luperox® DI), cumylperoxide, 1-hydroxycyclohexyl phenyl ketone, hydrogenperoxide/ascorbic acid. Iniferters such as benzyl-N,N-diethyldithiocarbamate can also be used. In some cases, more than one initiator may be used. The initiator may be a macroinitiator having a molecular weight of at least 1000 Daltons. In this case, the macroinitiator may be hydrophilic, hydrophobic, or responsive in nature.

Preferably, the residue of the initiator in a free-radical polymerisation comprises from 0 to 10% w/w of the copolymer based on the total weight of the monomers. More preferably the residue of the initiator in a free-radical polymerisation comprises from 0.001 to 8% w/w of the copolymer based on the total weight of the monomers. Especially the residue of the initiator in a free-radical polymerisation comprises from 0.001 to 5% w/w, of the copolymer based on the total weight of the monomers.

The use of a chain transfer agent and an initiator is preferred. However, some molecules can perform both functions.

Hydrophilic macroinitiators (where the molecular weight of the pre-formed polymer is at least 1000 Daltons) can be prepared from hydrophilic polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

Hydrophobic macroinitiators (where the molecular weight of the preformed polymer is at least 1000 Daltons) can be prepared from hydrophobic polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

Responsive macroinitiators (where the molecular weight of the preformed polymer is at least 1000 Daltons) can be prepared from responsive polymers synthesised by RAFT (or MADIX), or where a functional group of a preformed hydrophilic polymer, such as terminal hydroxyl group, can be post-functionalised with a functional halide compound, such as 2-bromoisobutyryl bromide, for use in Atom Transfer Radical Polymerisation (ATRP) with a suitable low valency transition metal catalyst, such as CuBr Bipyridyl.

The monofunctional monomer may comprise any carbon-carbon unsaturated compound which can be polymerised by an addition polymerisation mechanism, for example vinyl and allyl compounds. The monofunctional monomer may be hydrophilic, hydrophobic, amphiphilic, anionic, cationic, neutral or zwitterionic in nature. The monofunctional monomer may be selected from but not limited to monomers such as:

vinyl acids, vinyl acid esters, vinyl aryl compounds, vinyl acid anhydrides, vinyl amides, vinyl ethers, vinyl amines, vinyl aryl amines, vinyl nitriles, vinyl ketones, and derivatives of the aforementioned compounds as well as corresponding allyl variants thereof.

Other suitable monofunctional monomers include: hydroxyl-containing monomers and monomers which can be post-reacted to form hydroxyl groups, acid-containing or acid-functional monomers, zwitterionic monomers and quaternised amino monomers. Oligomeric, polymeric and di- or multi-functionalised monomers may also be used, especially oligomeric or polymeric (meth)acrylic acid esters such as mono(alkyl/aryl) (meth)acrylic acid esters of polyalkyleneglycol or polydimethylsiloxane or any other mono-vinyl or allyl adduct of a low molecular weight oligomer. Mixtures of more than one monomer may also be used to give statistical, graft, gradient or alternating copolymers.

Vinyl acids and derivatives thereof include: (meth)acrylic acid, fumaric acid, maleic acid, itaconic acid vinyl sulfonic acid, vinyl phosphoric acid, 2-acrylamido 2-methylpropane sulfonic acid, and acid halides thereof such as (meth)acryloyl chloride. Vinyl acid esters and derivatives thereof include: C1 to C20 alkyl(meth)acrylates (linear & branched) such as for example methyl (meth)acrylate, stearyl (meth)acrylate and 2-ethyl hexyl (meth)acrylate; aryl(meth)acrylates such as for example benzyl (meth)acrylate; tri(alkyloxy)silylalkyl(meth)acrylates such as trimethoxysilylpropyl(meth)acrylate; and activated esters of (meth)acrylic acid such as N-hydroxysuccinamido (meth)acrylate. Vinyl aryl compounds and derivatives thereof include: styrene, acetoxystyrene, styrene sulfonic acid, 2- and 4-vinyl pyridine, vinyl naphthalene, vinylbenzyl chloride and vinyl benzoic acid. Vinyl acid anhydrides and derivatives thereof include: maleic anhydride. Vinyl amides and derivatives thereof include: (meth)acrylamide, N-(2-hydroxypropyl)methacrylamide, N-vinyl pyrrolidone, N-vinyl formamide, (meth)acrylamidopropyl trimethyl ammonium chloride, [3-((meth)acrylamido)propyl]dimethyl ammonium chloride, 3-[N-(3-(meth)acrylamidopropyl)-N,N-dimethyl]aminopropane sulfonate, methyl(meth)acrylamidoglycolate methyl ether and N-isopropyl(meth)acrylamide. Vinyl ethers and derivatives thereof include: methyl vinyl ether. Vinyl amines and derivatives thereof include: dimethylaminoethyl(meth)acrylate, diethylaminoethyl(meth)acrylate, diisopropylaminoethyl(meth)acrylate, mono-t-butylaminoethyl(meth)acrylate, morpholinoethyl(meth)acrylate and monomers which can be post-reacted to form amine groups, such as N-vinyl formamide. Vinyl aryl amines and derivatives thereof include: vinyl aniline, 2 and 4-vinyl pyridine, N-vinyl carbazole and vinyl imidazole. Vinyl nitriles and derivatives thereof include: (meth)acrylonitrile. Vinyl ketones or aldehydes and derivatives thereof including acrolein.

Hydroxyl-containing monomers include: vinyl hydroxyl monomers such as hydroxyethyl(meth)acrylate, 1- and 2-hydroxy propyl(meth)acrylate, glycerol mono(meth)acrylate and sugar mono(meth)acrylates such as glucose mono(meth)acrylate. Monomers which can be post-reacted to form hydroxyl groups include: vinyl acetate, acetoxystyrene and glycidyl(meth)acrylate. Acid-containing or acid functional monomers include: (meth)acrylic acid, styrene sulfonic acid, vinyl phosphonic acid, vinyl benzoic acid, maleic acid, fumaric acid, itaconic acid, 2-(meth)acrylamido 2-ethyl propanesulfonic acid, mono-2-((meth)acryloyloxy)ethyl succinate and ammonium sulfatoethyl (meth)acrylate. Zwitterionic monomers include: (meth)acryloyl oxyethylphosphoryl choline and betaines, such as [2-((meth)acryloyloxy)ethyl] dimethyl-(3-sulfopropyl)ammonium hydroxide. Quaternised amino monomers include: (meth)acryloyloxyethyltri-(alkyl/aryl)ammonium halides such as (meth)acryloyloxyethyltrimethyl ammonium chloride.

Vinyl acetate and derivatives thereof can also be utilised.

Oligomeric and polymeric monomers include: oligomeric and polymeric (meth)acrylic acid esters such as mono(alk/aryl)oxypolyalkyleneglycol(meth)acrylates and mono(alk/aryl)oxypolydimethyl-siloxane(meth)acrylates. These esters include for example: monomethoxy oligo(ethyleneglycol) mono(meth)acrylate, monomethoxy oligo(propyleneglycol) mono(meth)acrylate, monohydroxy oligo(ethyleneglycol) mono(meth)acrylate, monohydroxy oligo(propyleneglycol) mono(meth)acrylate, monomethoxy poly(ethyleneglycol) mono(meth)acrylate, monomethoxy poly(propyleneglycol) mono(meth)acrylate, monohydroxy poly(ethyleneglycol) mono(meth)acrylate and monohydroxy poly(propyleneglycol) mono(meth)acrylate. Further examples include: vinyl or allyl esters, amides or ethers of pre-formed oligomers or polymers formed via ring-opening polymerisation such as oligo(caprolactam), oligo(caprolactone), poly(caprolactam) or poly(caprolactone), or oligomers or polymers formed via a living polymerisation technique such as poly(1,4-butadiene).

The corresponding allyl monomers to those listed above can also be used where appropriate.

Examples of monofunctional monomers are: Amide-containing monomers such as (meth)acrylamide, N-(2-hydroxypropyl)methacrylamide, N,N′-dimethyl(meth)acrylamide, N and/or N′-di(alkyl or aryl) (meth)acrylamide, N-vinyl pyrrolidone, [3-((meth)acrylamido)propyl]trimethyl ammonium chloride, 3-(dimethylamino)propyl(meth)acrylamide, 3-[N-(3-(meth)acrylamidopropyl)-N,N-dimethyl]aminopropane sulfonate, methyl (meth)acrylamidoglycolate methyl ether and N-isopropyl(meth)acrylamide; (Meth)acrylic acid and derivatives thereof such as (meth)acrylic acid, (meth)acryloyl chloride (or any halide), (alkyl/aryl)(meth)acrylate; functionalised oligomeric or polymeric monomers such as monomethoxy oligo(ethyleneglycol) mono(meth)acrylate, monomethoxy oligo(propyleneglycol) mono(meth)acrylate, monohydroxy oligo(ethyleneglycol) mono(meth)acrylate, monohydroxy oligo(propyleneglycol) mono(meth)acrylate, monomethoxy poly(ethyleneglycol) mono(meth)acrylate, monomethoxy poly(propyleneglycol) mono(meth)acrylate, monohydroxy poly(ethyleneglycol) mono(meth)acrylate, monohydroxy poly(propyleneglycol) mono(meth)acrylate, glycerol mono(meth)acrylate and sugar mono(meth)acrylates such as glucose mono(meth)acrylate; vinyl amines such as aminoethyl(meth)acrylate, dimethylaminoethyl(meth)acrylate, diethylaminoethyl(meth)acrylate, diisopropylaminoethyl(meth)acrylate, mono-t-butylamino(meth)acrylate, morpholinoethyl(meth)acrylate; vinyl aryl amines such as vinyl aniline, vinyl pyridine, N-vinyl carbazole, vinyl imidazole, and monomers which can be post-reacted to form amine groups, such as vinyl formamide; vinyl aryl monomers such as styrene, vinyl benzyl chloride, vinyl toluene, α-methyl styrene, styrene sulfonic acid, vinyl naphthalene and vinyl benzoic acid; vinyl hydroxyl monomers such as hydroxyethyl (meth)acrylate, hydroxy propyl(meth)acrylate, glycerol mono(meth)acrylate or monomers which can be post-functionalised into hydroxyl groups such as vinyl acetate, acetoxy styrene and glycidyl(meth)acrylate; acid-containing monomers such as (meth)acrylic acid, styrene sulfonic acid, vinyl sulfonic acid, vinyl phosphoric acid, 2-acrylamido 2-methylpropane sulfonic acid, vinyl phosphonic acid, vinyl benzoic acid, maleic acid, fumaric acid, itaconic acid, 2-(meth)acrylamido 2-ethyl propanesulfonic acid and mono-2-((meth)acryloyloxy)ethyl succinate or acid anhydrides such as maleic anhydride; zwitterionic monomers such as (meth)acryloyl oxyethylphosphoryl choline and betaine-containing monomers, such as [2-((meth)acryloyloxy)ethyl]dimethyl-(3-sulfopropyl)ammonium hydroxide; quaternised amino monomers such as (meth)acryloyloxyethyltrimethyl ammonium chloride, vinyl acetate or vinyl butanoate or derivatives thereof.

The corresponding allyl monomer, where applicable, can also be used in each case.

Functional monomers, that is monomers with reactive pendant groups which can be pre or post-modified with another moiety following polymerisation can also be used such as for example glycidyl(meth)acrylate, tri(alkoxy)silylalkyl(meth)acrylates such as trimethoxysilylpropyl(meth)acrylate, (meth)acryloyl chloride, maleic anhydride, hydroxyalkyl(meth)acrylates, (meth)acrylic acid, vinylbenzyl chloride, activated esters of (meth)acrylic acid such as N-hydroxysuccinamido(meth)acrylate and acetoxystyrene.

Macromonomers (monomers having a molecular weight of at least 1000 Daltons) are generally formed by linking a polymerisable moiety, such as a vinyl or allyl group, to a pre-formed monofunctional polymer via a suitable linking unit such as an ester, an amide or an ether. Examples of suitable polymers include: mono functional poly(alkylene oxides) such as monomethoxy[poly(ethyleneglycol)] or monomethoxy[poly(propyleneglycol)], silicones such as poly(dimethylsiloxane)s, polymers formed by ring-opening polymerisation such as poly(caprolactone) or poly(caprolactam) or mono-functional polymers formed via living polymerisation such as poly(1,4-butadiene).

Preferred macromonomers include: monomethoxy[poly(ethyleneglycol)] mono(methacrylate), monomethoxy[poly(propyleneglycol)] mono(methacrylate) and mono(meth)acryloxypropyl-terminated poly(dimethylsiloxane).

When the monofunctional monomer is providing the necessary hydrophilicity in the copolymer, it is preferred that the monofunctional monomer is a residue of a hydrophilic monofunctional monomer, preferably having a molecular weight of at least 1000 Daltons.

Hydrophilic monofunctional monomers include: (meth)acryloyl chloride, N-hydroxysuccinamido(meth)acrylate, styrene sulfonic acid, maleic anhydride, (meth)acrylamide, N-(2-hydroxypropyl)methacrylamide, N-vinyl pyrrolidinone, N-vinyl formamide, quaternised amino monomers such as (meth)acrylamidopropyl trimethyl ammonium chloride, [3-((meth)acrylamido)propyl]trimethyl ammonium chloride and (meth)acryloyloxyethyltrimethyl ammonium chloride, 3-[N-(3-(meth)acrylamidopropyl)-N,N-dimethyl]aminopropane sulfonate, methyl(meth)acrylamidoglycolate methyl ether, glycerol mono(meth)acrylate, monomethoxy and monohydroxy oligo(ethylene oxide) (meth)acrylate, sugar mono(meth)acrylates such as glucose mono(meth)acrylate, (meth)acrylic acid, vinyl phosphonic acid, fumaric acid, itaconic acid, 2-(meth)acrylamido 2-ethyl propanesulfonic acid, mono-2-((meth)acryloyloxy)ethyl succinate, ammonium sulfatoethyl (meth)acrylate, (meth)acryloyl oxyethylphosphoryl choline and betaine-containing monomers such as [2-((meth)acryloyloxy)ethyl] dimethyl-(3-sulfopropyl)ammonium hydroxide. Hydrophilic macromonomers may also be used and include: monomethoxy and monohydroxy poly(ethylene oxide) (meth)acrylate and other hydrophilic polymers with terminal functional groups which can be post-functionalised with a polymerisable moiety such as (meth)acrylate, (meth)acrylamide or styrenic groups.

Hydrophobic monofunctional monomers include: C1 to C28 alkyl(meth)acrylates (linear and branched) and (meth)acrylamides, such as methyl(meth)acrylate and stearyl(meth)acrylate, aryl(meth)acrylates such as benzyl(meth)acrylate, tri(alkyloxy)silylalkyl(meth)acrylates such as trimethoxysilylpropyl(meth)acrylate, styrene, acetoxystyrene, vinylbenzyl chloride, methyl vinyl ether, vinyl formamide, (meth)acrylonitrile, acrolein, 1- and 2-hydroxy propyl(meth)acrylate, vinyl acetate, 5-vinyl 2-norbornene, Isobornyl methacrylate and glycidyl(meth)acrylate. Hydrophobic macromonomers may also be used and include: monomethoxy and monohydroxy poly(butylene oxide) (meth)acrylate and other hydrophobic polymers with terminal functional groups which can be post-functionalised with a polymerisable moiety such as (meth)acrylate, (meth)acrylamide or styrenic groups.

Responsive monofunctional monomers include: (meth)acrylic acid, 2- and 4-vinyl pyridine, vinyl benzoic acid, N-isopropyl(meth)acrylamide, tertiary amine (meth)acrylates and (meth)acrylamides such as 2-(dimethyl)aminoethyl(meth)acrylate, 2-(diethylamino)ethyl(meth)acrylate, diisopropylaminoethyl(meth)acrylate, mono-t-butylaminoethyl(meth)acrylate and N-morpholinoethyl(meth)acrylate, vinyl aniline, 2- and 4-vinyl pyridine, N-vinyl carbazole, vinyl imidazole, hydroxyethyl(meth)acrylate, hydroxypropyl(meth)acrylate, maleic acid, fumaric acid, itaconic acid and vinyl benzoic acid. Responsive macromonomers may also be used and include: monomethoxy and monohydroxy poly(propylene oxide) (meth)acrylate and other responsive polymers with terminal functional groups which can be post-functionalised with a polymerisable moiety such as (meth)acrylate, (meth)acrylamide or styrenic groups.

Monomers based on styrene or those containing an aromatic functionality such as styrene, α-methyl styrene, vinyl benzyl chloride, vinyl naphthalene, vinyl benzoic acid, N-vinyl carbazole, 2-, 3- or 4-vinyl pyridine, vinyl aniline, acetoxy styrene, styrene sulfonic acid, vinyl imidazole or derivatives thereof.

Preferred monomers used is connection with the present invention however are selected from the group consisting of :styrene, vinyl benzyl chloride, 2-vinyl pyridine, 4-vinyl pyridine, methyl acrylate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, glycidyl methacrylate.

The multifunctional monomer or brancher may comprise a molecule containing at least two vinyl groups which may be polymerised via addition polymerisation. The molecule may be hydrophilic, hydrophobic, amphiphilic, neutral, cationic, zwitterionic, oligomeric or polymeric. Such molecules are often known as cross-linking agents in the art and may be prepared by reacting any di- or multifunctional molecule with a suitably reactive monomer. Examples include: di- or multivinyl esters, di- or multivinyl amides, di- or multivinyl aryl compounds, di- or multivinyl alk/aryl ethers. Typically, in the case of oligomeric or polymeric di- or multifunctional branching agents, a linking reaction is used to attach a polymerisable moiety to a di- or multifunctional oligomer or polymer. The brancher may itself have more than one branching point, such as T-shaped divinylic oligomers or polymers. In some cases, more than one multifunctional monomer may be used. When the multifunctional monomer is providing the necessary hydrophilicity in the copolymer, it is preferred that the multifunctional monomer has a molecular weight of at least 1000 Daltons.

The corresponding allyl monomers to those listed above can also be used where appropriate.

Preferred multifunctional monomers or branchers include but are not limited to divinyl aryl monomers such as divinyl benzene; (meth)acrylate diesters such as ethylene glycol di(meth)acrylate, propyleneglycol di(meth)acrylate and 1,3-butylenedi(meth)acrylate; polyalkylene oxide di(meth)acrylates such as tetraethyleneglycol di(meth)acrylate, poly(ethyleneglycol) di(meth)acrylate and poly(propyleneglycol) di(meth)acrylate; divinyl(meth)acrylamides such as methylene bisacrylamide; silicone-containing divinyl esters or amides such as (meth)acryloxypropyl-terminated poly(dimethylsiloxane); divinyl ethers such as poly(ethyleneglycol)divinyl ether; and tetra- or tri-(meth)acrylate esters such as pentaerythritol tetra(meth)acrylate, trimethylolpropane tri(meth)acrylate or glucose di- to penta(meth)acrylate. Further examples include vinyl or allyl esters, amides or ethers of pre-formed oligomers or polymers formed via ring-opening polymerisation such as oligo(caprolactam), oligo(caprolactone), 1,3,5-triallyl-1,3,5-triazine-2,4,6(1H, 3H, 5H)trione poly(caprolactam) or poly(caprolactone), or oligomers or polymers formed via a living polymerisation technique such as oligo- or poly(1,4-butadiene).

Macro-crosslinkers or macro-branchers (multifunctional monomers having a molecular weight of at least 1000 Daltons) are generally formed by linking a polymerisable moiety, such as a vinyl or aryl group, to a pre-formed multifunctional polymer via a suitable linking unit such as an ester, an amide or an ether. Examples of suitable polymers include: di-functional poly(alkylene oxides) such as poly(ethyleneglycol) or poly(propyleneglycol), silicones such as poly(dimethylsiloxane)s, polymers formed by ring-opening polymerisation such as poly(caprolactone) or poly(caprolactam) or poly-functional polymers formed via living polymerisation such as poly(1,4-butadiene).

Preferred macrobranchers include: poly(ethyleneglycol) di(meth)acrylate, poly(propyleneglycol) di(meth)acrylate, methacryloxypropyl-terminated poly(dimethylsiloxane), poly(caprolactone) di(meth)acrylate and poly(caprolactam) di(meth)acrylamide.

Branchers include: methylene bisacrylamide, glycerol di(meth)acrylate, glucose di- and tri(meth)acrylate, oligo(caprolactam) and oligo(caprolactone), 1,3,5-triallyl-1,3,5-triazine-2,4,6 (1H;3H;5H)-trione. Multi end-functionalised hydrophilic polymers may also be functionalised using a suitable polymerisable moiety such as a (meth)acrylate, (meth)acrylamide or styrenic group.

Further branchers include: divinyl benzene, (meth)acrylate esters such as ethyleneglycol di(meth)acrylate, propyleneglycol di(meth)acrylate and 1,3-butylene di(meth)acrylate, oligo(ethylene glycol) di(meth)acrylates such as tetraethylene glycol di(meth)acrylate, tetra- or tri-(meth)acrylate esters such as pentaerthyritol tetra(meth)acrylate, trimethylolpropane tri(meth)acrylate and glucose penta(meth)acrylate. Multi end-functionalised hydrophobic polymers may also be functionalised using a suitable polymerisable moiety such as a (meth)acrylate, (meth)acrylamide or styrenic group.

Multifunctional responsive polymers may also be functionalised using a suitable polymerisable moiety such as a (meth)acrylate, (meth)acrylamide or styrenic group such as poly(propylene oxide) di(meth)acrylate.

Styrenic branchers, or those containing aromatic functionality are particularly preferred including divinyl benzene, divinyl naphthalene, acrylate or methacrylate derivatives of 1,4 or 1,3 or 1,2 derivatives of dihydroxy dimethyl benzene. And derivatives thereof.

### EXAMPLES

The present invention will now be explained in more detail by reference to the following non-limiting examples.

In the following examples, copolymers are described using the following nomenclature:
(MonomerG)_{g}(Monomer (Brancher L)ⱼ(Chain Transfer Agent)_{d}

wherein the values in subscript are the molar ratios of each constituent normalised to give the monofunctional monomer values as 100, that is, g+j=100. The degree of branching or branching level is denoted by l and d refers to the molar ratio of the chain transfer agent.

For example: Methacrylic acid₁₀₀ Ethyleneglycol dimethacrylate₁₅ Dodecane thiol₁₅ would describe a polymer containing methacrylic acid:ethyleneglycol dimethacrylate:dodecane thiol at a molar ratio of 100:15:15.

### Abbreviations:

### Monomers:

AMA—Allyl methacrylate

AMPS—2-Acrylamido-2-methylpropane sulfonic acid

BMA—n-Butyl methacrylate

HEMA—2-Hydroxyethyl methacrylate

MMA—Methyl methacrylate

VBC—4-Vinylbenzyl chloride

VPy—4-Vinylpyridine

### Branchers:

EGDMA—Ethylene glycol dimethacrylate

DVB—Divinylbenzenes, (80% grade)

### Chain Transfer Agents (CTAs)

DDT—Dodecanethiol

### Initiators

AIBN—Azobisisobutyronitrile

Luperox® LP—Lauroyl peroxide

Luperox® P—t-Butyl peroxybenzoate

### Solvents

THF—Tetrahydrofuran

BuOAc—n-Butyl acetate

MEK—Butan-2-one

NMP—N-Methyl-2-pyrrolidinone

### Hardeners

DIH—1,6,-Diiodohexane

TMHDA—Tetramethylhexane-1,6-diamine

All materials were obtained from the Aldrich Chemical Company with the exception of Luperox® LP and P which were obtained from Arkema Chemical Company, Desmodur® N3390 which was obtained from Bayer and Petex® 07-240/59 which was obtained from Sefar.

Triple Detection-Size Exclusion Chromatography was performed on a Viscotek triple detection instrument. The columns used were two ViscoGel HHR-H columns and a guard column with an exclusion limit for polystyrene of 107 g.mol-1.

THF was the mobile phase, the column oven temperature was set to 35 ° C., and the flow rate was 1 mL.min-1. The samples were prepared for injection by dissolving 10 mg of polymer in 1.5 mL of HPLC grade THF and filtered of with an Acrodisc® 0.2 μm PTFE membrane. 0.1 mL of this mixture was then injected, and data collected for 30 minutes. Omnisec was used to collect and process the signals transmitted from the detectors to the computer and to calculate the molecular weight.

### General Procedure:

Into a three-necked round bottom flask fitted in a DrySyn® Vortex overhead stirrer system and equipped with a condenser the required monomers and solvent were introduced. The solution was then degassed for one hour by bubbling nitrogen through it. The solution was then heated to the appropriate temperature and stirred at 320 revolutions per minute (rpm). Once the expected temperature had been reached, the initiator was added and the reaction was allowed to proceed for between 15 and 50 hours until the monomer conversion was found to be greater than 99% (measured by 1H NMR). The reaction mixture was cooled to room temperature and poured into a vessel. The polymers were characterised by Triple Detection-Size Exclusion Chromatography (TD-SEC).

### Example BP1

### VPy₅₀ST₂₀HEMA₃₀EGDMA₁₀DDT₁₂

4-Vinyl pyridine (9.8 g, 93.21 mmol), styrene (3.88 g, 37.25 mmol), 2-hydroxyethyl methacrylate (7.28 g, 55.94 mmol), ethylene glycol dimethacrylate (3.69 g, 18.63 mmol), dodecane thiol (4.53 g, 22.38 mmol) AIBN (0.40 g, 2.43 mmol) were dissolved in THF (68 g). The solution was degassed with nitrogen for one hour with constant agitation. The mixture was then heated to 65° C. for 17 hours. After 5 hours a second aliquot of AIBN (0.40 g, 2.43 mmol) was added. The solution was then heated for a further 12 hours before cooling to room temperature.

Membrane Preparation. Polymer BP1 (1 g) was dissolved in butanone (0.33 g). 1,6-diiodohexane (0.55 g, 1.66 mmol) was then added and the reagents were mixed to give a homogeneous solution. 1.5 ml of the solution was coated onto a 10×15 cm aluminium plate using a 100 micron application bar. The coating was left to dry at room temperature for 48 hours. The membrane was found to be cross-linked.

### Comparative Linear Examples

### Preparation of Linear Polymer 1-LP1

Poly(VPy₅₀-MMA₂₅-HEMA₂₅-DDT₂). 4-Vinyl pyridine (5.257 g, 50 mmol), methyl methacrylate (2.503 g, 25 mmol), 2-hydroxyethyl methacrylate (3.254 g, 25 mmol) and 1-dodecanethiol (0.405 g, 2 mmol) were weighed into a 3-neck round bottomed flask. Tetrahydrofuran (26.6 g) was added and once a solution had been formed AIBN, (164 mg, 1 mmol) was added. The solution was stirred mechanically under a nitrogen atmosphere and then heated to 65° C. for 24 hours. A second portion of initiator (60 mg) was added and the reaction mixture heated at 65° C. for a further 6 hours before being allowed to cool to ambient temperature. A viscous yellow-orange solution of resultant polymer was then dried in a vacuum oven overnight (at 45° C.) to give a yellow powder (10.90 g, 95.6%), 4.38 mmol/g N.

### Preparation of Linear Polymer 2—LP2

Poly(VPy₅₀-MMA₂₀-BMA₁₀-HEMA₁₀-DDT₁). 4-Vinyl pyridine (5.257 g, 50 mmol), methyl methacrylate (2.002 g, 20 mmol), n-butyl methacrylate (1.422 g, 10 mmol), 2-hydroxyethyl methacrylate (1.301 g, 10 mmol) and 1-dodecanethiol (0.202 g, 1 mmol) were weighed into a 3-neck round bottomed flask. Tetrahydrofuran (23.8 g) was added and, once a solution had been formed, AIBN (164 mg, 1 mmol) was added. The solution was stirred mechanically under a nitrogen atmosphere and then heated to 65° C. for 24 hours. A second portion of initiator (60 mg) was added and the reaction mixture heated at 65° C. for a further 6 hours before being allowed to cool to ambient temperature.

Table 1 provides a summary of the synthesised polymers.

TABLE 1

| | | | Reaction | | | |
|---|---|---|---|---|---|---|
| Example | Solids/ | | Temperature/ | | Initiator/ | Reaction |
| number | weight % | Solvent | ° C. | Initiator | weight % | time/hours |
| LP1 | 30 | THF | 65 | AIBN | 1.5 | 30 |
| LP2 | 30 | THF | 65 | AIBN | 1.5 | 30 |
| BP1 | 30 | THF | 65 | AIBN | 1.4 | 34 |
| BP2 | 30 | THF | 65 | AIBN | 1.4 | 48 |
| BP3 | 30 | THF | 65 | AIBN | 1.4 | 48 |
| BP4 | 30 | THF | 65 | AIBN | 1.5 | 48 |
| BP5 | 30 | THF | 65 | AIBN | 1.5 | 24 |
| BP6 | 25 | NMP | 125 | Luperox ®P | 1.0 | 24 |
| BP7 | 40 | NMP | 125 | Luperox ®P | 1.0 | 24 |

Table 2 provides the composition and analytical data for the synthesised examples in Table 1.

TABLE 2

| Example | | | | | |
|---|---|---|---|---|---|
| number | COMPOSITION | Mn/kDa | Mw/kDa | Mw/Mn | α |
| LP1 | VPy₅₀MMA₂₅HEMA₂₅DDT₂ | ND | ND | ND | ND |
| LP2 | VPy₅₀MMA₂₀BMA₂₀HEMA₁₀DDT₂ | 11.6 | 17.3 | 1.5 | 0.69 |
| BP1 | VPy₅₀ST₂₀HEMA₃₀EGDMA₁₀DDT₁₂ | 4.9 | 16.9 | 3.5 | 0.39 |
| BP2 | Vpy₅₀MMA₂₅HEMA₂₅EGDMA₁₀DDT₁₂ | 3.5 | 19.9 | 5.7 | 0.35 |
| BP3 | VPy₅₀MMA₂₀BMA₂₀HEMA₁₀EGDMA₁₀DDT₁₂ | 2.7 | 14.6 | 5.4 | 0.36 |
| BP4 | VPy₆₅BMA₁₀HEMA₂₅EGDMA₁₀DDT₁₂ | 5.2 | 16.25 | 3.1 | 0.29 |
| BP5 | VBC₅₀MMA₂₀BMA₂₀HEMA₁₀EGDMA₁₀DDT₁₂ | 3.2 | 29.3 | 9.1 | 0.52 |
| BP6 | AMPS₅₀AMA₄₀BMA₁₀ DVB₁₀ DDT₁₅ | # | # | # | # |
| BP7 | AMPS₅₀ST₃₀HEMA₂₀DVB₁₀DDT₁₂ | # | # | # | # |

Mn represents the number average molecular weight in kDa
Mw represents the weight average molecular weight in kDa
Mw/Mn represents the polydispersity of the polymers
α—represents the Mark-Houwink alpha value.
ND—Not determined
# Fully soluble in reaction solvent but could not be dissolved in GPC eluent

Preparation of anion exchange membrane (AEM) films. The membranes were cured by reacting the polymers (as solutions in MEK; 65 weight % in the case of branched copolymers (BP) and 50 weight % in the case of linear polymers (LP)) with 1,6-di-iodohexane and casting the solution onto a smooth substrate and allowing the mixture to cure. In some cases the polymers were cast incorporating an inert woven mesh fabric support (Sefar Petex® 07-240/59) while in other cases the thickness of the membranes was controlled via the type of application roller used.

Mixing was carried out in weight to weight ratios of 1.00:0.62 (BP2:DIH that is, 1.0 g polymer and 0.62 g DIH), and 1.00:0.51 (for BP1, BP3, BP4 to DIH) and 1.00:0.74 (LP2:DIH) based on 100% polymer and crosslinker.

Approximately 20 g of polymer/cross-linker solution was stirred vigorously for several minutes and degassed in a vacuum desiccator to remove any entrapped air bubbles. The resultant solution was completely clear and could be used directly for the casting. The membranes were cast on three different smooth plates; stainless steel 304, nickel and polyethylene. For the reinforced membranes a 100 μm woven net from Sefar (Petex® 07-240/59) was placed on the plate and a smooth round-bar applicator of 200 μm was used to cast the solution on top.

The casting was carried out with a speed of approximately 1 cm/minute of the applicator to allow for a full impregnation of the net with polymer solution.

Preparation of anion exchange membrane (AEM) using BPS. A 65 weight percent solution of BP5 in MEK and TMHDA were mixed in a weight ratio of 1.00:0.19 (based on the weight of dry polymer to hardener). Any air bubbles entrapped as a result of the mixing process were removed by de-gassing in a vacuum desiccator. The casting solution was then applied to a 10×15 cm aluminium plate and the film allowed to air dry for several hours before being placed in an oven at 60° C. for 24 hours. The resulting yellow membrane film was found to be cross-linked.

Casting of thin films. To a solution of BP2 prepared as described above was added DIH (at a ratio or 1.0 g polymer to 0.62 g of DIH—based upon 100% solid polymer). This solution was drawn down as a wet film on to a highly polished 304 stainless steel sheet using a wire-wound 50 micron coating bar and the coating left to air dry for 24 hours before being placed in an oven and kept at 60° C. for 12 hours. The resulting cross-linked film was delaminated from the metal surface by immersion in a 50:50 weight/weight isopropanol/water mixture for several hours and then left to dry in air. The film had thickness of between 25 to 30 microns when measured by micrometer and was robust enough to be handled.

Preparation of CEM films. Reaction of pendant allyl groups. To a solution of polymer BP6 (1.9 mmol/g allyl groups) in NMP (4.00 g, 25 weight %) was added Luperox® LP (0.10 g, 10 weight %) and the components thoroughly mixed until complete dissolution of the peroxide occurred. The solution was spread on an aluminium sheet and heated in an oven at 80° C. for 48 hours to give an insoluble yellow transparent film.

Reaction of OH with isocyanate. To a solution of polymer BP7 (OH=1 0 mmol/g) in NMP (40 weight % solids; 6.11 g) was added Desmodur® N3390 (0.45 g, 0.85 equivalent). Once these were thoroughly mixed on a sample roller a solution of stannous octoate (1.0 weight % in BuOAc) was added and mixed. Air bubbles entrapped as a result of mixing were removed by de-gassing in a vacuum desiccator. The solution was then spread on to an aluminium sheet and placed in an oven at 60° C. for 48 hours. This gave an insoluble yellow clear film.

TABLE 3

| Membrane | | | | | | |
|---|---|---|---|---|---|---|
| Reference | Polymer | | | Average film | | |
| Number | used | Hardener | Support | thickness/μm | Type | Functionality |
| M1 | BP1 | DIH | None | 42 | AEM | Strong base |
| M2 | BP1 | DIH | None | 232 | AEM | Strong base |
| M3 | BP1 | DIH | Petex ® | 180 | AEM | Strong base |
| M4 | BP3 | DIH | None | 41 | AEM | Strong base |
| M5 | BP3 | DIH | None | 205 | AEM | Strong base |
| M6 | BP3 | DIH | Petex ® | 230 | AEM | Strong base |
| M7 | BP4 | DIH | Petex ® | 225 | AEM | Strong base |
| M8 | BP2 | DIH | Petex ® | 155 | AEM | Strong base |
| M9 | LP2 | DIH | None | 148 | AEM | Strong base |
| M10 | BP5 | TMHDA | None | ND | AEM | Strong base |
| M11 | BP6 | Luperox ® | None | ND | CEM | Strong acid |
| | | LP | | | | |
| M12 | BP7 | Desmodur ® | None | ND | CEM | Strong acid |
| | | N3390 | | | | |

Petex ® 07-240/59 from Sefar was used as the reinforcing support.
ND—not determined

### Membrane Characterization

Electrical Resistance. The membrane under test was placed in a cell consisting of two measuring Haber-Lugin capillary electrodes placed adjacent to the membrane in order to measure the potential drop as a function of current density. The outer chambers contained the working electrodes and were circulated with 0.5 M sodium sulfate (Na₂SO₄) solution. Both buffer chambers adjacent to the electrodes contained 0.5 M sodium chloride (NaCl) solution to protect the inner chambers from the acid produced at the electrodes. The inner chambers were circulated with a different batch of 0.5 M NaCl. In these chambers, the two shielding and the two electrode compartments were paired to keep the concentration in the compartments constant.

A current was placed across the cell and the limiting current density (LCD) was measured by following the increase in resistance with increasing current density. The electrical resistance of the membrane was determined in relation to the limiting current density LCD

Permselectivity. In addition to membrane resistance, the selectivity of the membranes is an important feature with respect to the efficiency of the process to which the membrane is applied. The permselectivity of the membrane can be determined via different methods like chronopotentiometry, Nernst potential and limiting current density (LCD) ratio. The inventors employed the Nernst potential method in this application. The permselectivity of the membranes was determined using a cell consisting of two compartments fitted with two Ag/AgCI reference electrodes separated by the membrane under test. Potassium chloride (KCl) 0.50 M was circulated through one chamber and potassium chloride (KCl) 0.10 M was circulated through the other chamber at 25° C. Using potassium chloride (KCl) to measure the membrane potential ensured that no liquid polarization occurs as potassium ions (K⁺) and chloride ions (CI⁻) have similar diffusion coefficients in water. The potential and the measured electrical potential can be linked directly to the apparent selectivity via equation 1:

Ψ^{m}=[φ/φ′]×100% Equation 1

wherein:

Ψ^{m} is the apparent permselectivity and

φ and φ′ are the measured and ideal electrical (Nernst) potential difference.

Using 0.50 M and 0.10 M potassium chloride (KCI) provides a theoretical voltage drop (φ) of 36.94 MV.

Table 4 provides electrochemical characterisation of unsupported membrane films.

TABLE 4

| Membrane | | Average | Resis- | | Conduc- |
|---|---|---|---|---|---|
| reference | | Film thick- | tance^{†}/ | Permselec- | tivity^{†}/ |
| number | Polymer | ness^{§}/μm | Ω · cm2 | tivity^{¶}/% | mScm⁻¹ |
| M1 | BP1 | 42 | 0.66 | 99 | 6.4 |
| M2 | BP1 | 232 | 3.87 | 97 | 6.0 |
| M4 | BP2 | 41 | 1.45 | 99 | 2.8 |
| M5 | BP2 | 205 | 3.77 | 98 | 5.4 |
| M9 | LP2 | 148 | 2.71 | 83 | 5.5 |

^{§}measured wet;
^{†}measured in 0.5M NaCl;
^{¶}Nernst potential in 0.1M/0.5M KCl

Table 5 provides ion-exchange capacity (IEC) of membranes.

TABLE 5

| Membrane reference | | |
|---|---|---|
| number | Polymer Used | IEC^{‡}/mmolg⁻¹ |
| M1 | BP1 | 1.24 |
| M4 | BP3 | 1.52 |
| M7 | BP4 | 1.53 |
| M8 | BP2 | 1.10 |

^{‡}determined by back titration with silver nitrate (AgNO₃) on the exchanged chloride ions, for the dry unbacked ion-exchange membrane polymer

The ion exchange capacity (IEC) was measured on pieces of the dried unbacked films that had been completely ionised (by immersion in sodium chloride (NaCl) solution), followed by thorough rinsing in demineralised water followed by drying in a vacuum oven). The chloride ions were then exchanged with sulfate ions by immersion in sodium sulfate followed by back-titration of chloride ions.

Table 6 presents the measurement of swelling in demineralised water compared to air.

TABLE 6

| Membrane | | Swelling behaviour | | | |
|---|---|---|---|---|---|
| reference | Polymer | w/w/% | L/L/% | W/W/% | H/H/% |
| M2 | BP1 | 16 | 5 | 4 | 5 |
| M3 | BP1 | 14 | 1 | 3 | 17 |
| M5 | BP2 | 17 | 4 | 4 | 6 |
| M6 | BP2 | 16 | 2 | 1 | 20 |
| M7 | BP13 | 15 | 3 | 1 | 17 |
| M8 | BP4 | 9 | 0 | 0 | 12 |
| M9 | LP2 | 13 | 3 | 3 | 7 |

In Table 6 w/w = weight/weight, that is, percentage (%) increase upon swelling, L/L = length; W/W = width; H/H = height, % is the change in dimensional magnitude.

Table 7 presents the measurement of swelling in 0.5M sulfuric acid (H₂SO₄) compared to demineralised water.

TABLE 7

| Membrane | | Swelling behaviour | | | |
|---|---|---|---|---|---|
| reference | Polymer | w/w/% | L/L/% | W/W/% | H/H/% |
| M2 | BP1 | 15 | 5 | 5 | 3 |
| M3 | BP1 | 9 | 1 | 0 | 7 |
| M5 | BP2 | 15 | 5 | 6 | 0 |
| M6 | BP2 | 13 | −1 | 0 | 15 |
| M7 | BP3 | 12 | 0 | −1 | 4 |
| M8 | BP4 | 12 | 0 | 0 | 21 |

| | | |
|---|---|---|
| M9 | LP2 | Too brittle to handle |

Table 8 presents the measurement of swelling in sodium hydroxide (NaOH) 1.0M compared to demineralised water.

TABLE 8

| Membrane | | Swelling behaviour | | | |
|---|---|---|---|---|---|
| reference | Polymer | w/w/% | L/L/% | W/W/% | H/H/% |
| M2 | BP1 | −2 | 2 | 3 | 1 |
| M3 | BP1 | −2 | 1 | 1 | 20 |
| M4 | BP2 | Broken | 2 | 1 | 12 |
| M6 | BP2 | −4 | −1 | 2 | 22 |
| M7 | BP3 | 0 | 0 | −1 | −15 |
| M8 | BP4 | 1 | 0 | 0 | 9 |

| | | |
|---|---|---|
| M9 | LP2 | Membrane disintegrated |

w/w = weight/weight, that is, percentage (%) increase upon swelling L/L = length; W/W = width; H/H = height, percentage (%) change in dimensional magnitude.

Table 9 presents the mechanical strength analysis of the polymer membranes.

TABLE 9

| Membrane | Membrane reference | Average film | Maximum force^{†}/ |
|---|---|---|---|
| reference | number | thickness^{§}/μm | MPa |
| M1 | BP1 | 42 | 1.8 |
| M2 | BP1 | 232 | 1.3 |
| M3 | BP1 | 165 | 24 |
| M4 | BP3 | 41 | 4.2 |
| M5 | BP3 | 205 | 1.1 |
| M6 | BP3 | 230 | 20 |
| M7 | BP3 | 225 | 13 |
| M8 | BP2 | 155 | 17 |
| M9 | LP2 | 145 | Too fragile to |
| | | | measure |

^{§}measured wet;
^{†}force required to break the material.

Mechanical strength analyses were measured on strips of the membranes using a Zwick Z1.0/TH1S table top tensile strength test apparatus according to ISO 37 and wherein the tensile force applied to cause breakage was recorded.

Therefore, the branched polymer membranes (M1, M2, M4 and M5) all showed higher permselectivity than the linear material (M9). This high permselectivity is particularly desirable where the material is to be used for ion-selection applications.

Membrane M8, prepared using polymer BP 4 showed reduced swelling in water, acid and base compared to the other polymers. Membrane M9, prepared using linear polymer LP2 was not stable in the dilute acid and base solutions showing it's reduced inherent strength when compared to the membranes prepared from the branched polymers.

The membranes prepared using the branched polymers also had a higher tensile strength than the linear example. Their strength can be further increased by use of an inert backing material.

It has also been found that thin, robust “unbacked” polymer films can be prepared using the branched copolymers which are suitable for a number of electro-separation applications where high permselectivity, good chemical resistance, and low swelling is required.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The inclusion or discussion of a reference is not an admission that it is prior art to the present invention, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

1. A method of using a branched addition copolymer wherein the branched addition copolymer is cured to form a cross-linked film or membrane formulation and wherein the branched addition copolymer is obtainable by an addition polymerisation process, and wherein the branched addition polymer comprises a weight average molecular weight of 2,000 Da to 1,500,000 Da.

2. The method of claim 1 wherein the branched addition copolymer comprises:
at least two chains which are covalently linked by a bridge other than at their ends; and wherein
the at least two chains comprise at least one ethyleneically monounsaturated monomer, and wherein
the bridge comprises at least one ethyleneically polyunsaturated monomer; and
wherein
the polymer comprises a residue of a chain transfer agent and optionally a residue of an initiator; and wherein
the mole ratio of polyunsaturated monomer(s) to monounsaturated monomer(s) is in a range of from 1:100 to 1:4.

3. The method of claim 1 wherein the branched addition polymer is cured after formation of the branched addition polymer in the addition polymerisation process.

4. The method of claim 1 wherein the branched addition copolymer is cured by the addition of a reactive polymer, oligomer or small molecular weight reactive molecule.

5. The method of claim 1 wherein the branched addition copolymer is cured by means of thermal, photolytic, oxidative, reductive reaction or by the addition of a catalyst or initiator.

6. The method of claim 1 wherein the branched addition copolymer is prepared from monomers comprising one or more of the following groups: hydroxyl, mercapto, amino, carboxylic, epoxy, isocyanate, pyridinyl, vinyl, allyl, (meth)acrylate and styrenyl.

7. The method of claim 6 wherein the branched addition copolymer is cured by means of the reaction of mutually reactive functional groups provided on the monomers.

8. The method of claim 1 wherein the branched copolymer comprises less than 1% impurity.

9. The method of claim 1 wherein the branched addition polymer comprises a weight average molecular weight of 3,000 Da to 900,000 Da.

10. The method of claim 1 wherein at least one of the monounsaturated monomer(s) and polyunsaturated monomer(s) and chain transfer agent(s) is a hydrophilic residue.

11. The method of claim 1 wherein at least one of one of the monounsaturated monomer(s) and polyunsaturated monomer(s) and chain transfer agent(s) is a hydrophobic residue.

12. The method of claim 1 wherein the film or membrane is used in the application areas selected from the group consisting of:
medical separation and diagnostics applications, industrial purification and separation, ion-exchange applications, desalination, water purification, gas separation, pervaporation, fuel cells, energy generation, energy storage, filtration and sensors.

13. The method of claim 1 wherein the branched addition copolymer comprises units selected from the group consisting of:
styrene, vinyl benzyl chloride, 2-vinyl pyridine, 4-vinyl pyridine, methyl acryiate, ethyl acrylate, methyl methacrylate, ethyl methacrylate, butyl methacrylate, butyl acrylate, acrylic acid, methacrylic acid, 2-hydroxylethyl methacrylate, 2-hydroxy ethyl acrylate, 2-hydroxypropyl acrylate, 2-hydroxypropyl methacrylate, acrylamide, methacrylamide, dimethyl acrylamide, dimethyl(meth)acrylamide, allyl methacrylate, dimethylaminoethyl methacrylate, dimethylaminoethyl acrylate, diethylaminoethyl methacrylate, diethylaminoethyl acrylate, styrene sulfonic acid, vinylsulfonic acid, vinyl phosphoric acid, 2-acrylamido 2-methylpropane sulfonic acid, glycidyl methacrylate, divinyl benzene, ethyleneglycol dimethacrylate, ethyleneglycol diacrylate, triethylene glycol dimethacrylate, tetraethyleneglycol dimethacrylate, triethyleneglycol diacrylate, tetraethyleneglycol diacrylate, 1,3,5-triallyl-1,3,5-triazine-2,4,6(1H,3H,5H)-thone, dodecane thiol, hexane thiol, 2-mercaptoethanol and fragments arising from azobis isobutyronitrile, di-f-butyl peroxide and f-butyl peroxybenzoate.

14. The method of claim 1 wherein the branched addition copolymer comprises units selected from the group consisting of:
styrene, vinylbenzyl chloride, glycidyl methacrylate, vinylbenzyl chloride, 2-vinyl pyridine, 4-vinyl pyridine, methyl acrylate, methyl methacrylate, butyl methacrylate, butyl acrylate, acrylic acid, methacrylic acid, acrylamide, methacrylamide, dimethyl acrylamide, dimethyl(meth)acrylamide, styrene sulfonic acid, 2-acrylamido 2-methylpropane sulfonic acid, divinyl benzene, ethyleneglycol dimethacrylate, ethyleneglycol diacrylate, triethylene glycol dimethacrylate, dodecane thiol, hexane thiol, 2-mercaptoethanol, azobis isobutyronitrile, di-f-butyl peroxide and f-butyl peroxybenzoate.

15. A film comprising a cured branched addition copolymer as described in claim 1.

16. A membrane comprising a cured branched addition copolymer as described claim 1.

17. The film of claim 15 wherein the film further comprises a hardener selected from the group consisting of: dibromopentane, dibromo hexane, dibromoheptane, dibromooctane, diiodo pentane, diidohexane, diiodoheptane, diiodooctane, tetramethylhexane 1,6 diaminohexane, tertamethyethylene diamine, tetramethylbutane 1,4 diamine, tolylene diisocyanate and hexamethylene diisocyanate.

18. The film of claim 15 wherein the film further comprises a support material.

19. The film of claim 15 wherein the film comprises a permselectivity above 80%.

20. The film of claim 15 wherein the film comprises a permselectivity above 90%.

21. The film of claim 15 wherein the film shows an electrical resistance below 5 Ω cm⁻².

22. The membrane of claim 16 wherein the membrane further comprises a hardener selected from the group consisting of: dibromopentane, dibromo hexane, dibromoheptane, dibromooctane, diiodo pentane, diidohexane, diiodoheptane, diiodooctane, tetramethylhexane 1,6 diaminohexane, tertamethyethylene diamine, tetramethylbutane 1,4 diamine, tolylene diisocyanate and hexamethylene diisocyanate.

23. The membrane of claim 16 wherein the membrane further comprises a support material.

24. The membrane of claim 16 wherein the membrane comprises a permselectivity above 80%.

25. The membrane of claim 16 wherein the membrane comprises a permselectivity above 90%.

26. The membrane of claim 16 wherein the membrane shows an electrical resistance below 5 Ω cm⁻².
